(19) United States
(12) Patent Application Publication
(10) Pub. No.: US 2021/0327466 A1
(43) Pub. Date: Oct. 21, 2021

(54) OPTICAL DISK, METHOD OF MANUFACTURING SAME, OPTICAL INFORMATION DEVICE, AND INFORMATION PROCESSING METHOD

(71) Applicant: Panasonic Intellectual Property Management Co., Ltd., Osaka (JP)

(72) Inventor: Yoshiaki KOMMA, Osaka (JP)

(21) Appl. No.: 17/360,286

(22) Filed: Jun. 28, 2021

Related U.S. Application Data
(63) Continuation of application No. PCT/JP2020/033368, filed on Sep. 3, 2020.

(30) Foreign Application Priority Data
Jan. 15, 2020 (JP) 2020-004175

(51) Int. Cl. G11B 7/24067; G11B 7/258; G11B 7/24035; G11B 7/257; G11B 7/24062; G11B 7/1374; G11B 7/1376; G11B 7/1378

(52) U.S. Cl. CPC G11B 7/24067; G11B 7/258; G11B 7/24035; G11B 7/257; G11B 2007/13727; G11B 7/1374; G11B 7/1376; G11B 7/1378; G11B 7/24062

(57) ABSTRACT

Provided is a method of manufacturing an optical disk having at least a cover layer, a first information recording surface, a first intermediate layer, a second information recording surface, a second intermediate layer, and a third information recording surface in order from a surface irradiated with a light beam on at least one side, wherein a numerical aperture of an objective lens that converges the light beam on any of the recording surface of the optical disk when information recording or information reproduction of the optical disk is performed is 0.91, standard value dk of each thickness from the surface to the first to third information recording surfaces is set on the premise of standard refractive index no, where k is 1, 2, 3, and a target value of each actual thickness from the surface to the first to third information recording surfaces is determined by a product of conversion coefficient g(n) depending on refractive index n from the first to third information recording surfaces, and standard value dk.

### TECHNICAL FIELD

The present invention relates to an optical disk that irradiates light to record or reproduce information, and in particular, to a structure of layer spacing of an optical disk having three or more layers of information recording surfaces, and a method or a device of reproducing or recording information of the multilayer optical disk on the multilayer optical disk.

### BACKGROUND ART

As commercially available high-density, large-capacity optical information recording media, there are optical disks called digital versatile disks (DVDs) and Blu-ray (registered trademark) disks (hereinafter referred to as BDs). These optical disks have been widely used as recording media for recording images, music, and computer data. Further, optical disks that each have a plurality of recording layers in order to further increase a recording capacity have also been proposed as described PTLs 1 to 4.

FIG. 16 is a diagram showing a configuration of a conventional optical disk and an optical pickup. Divergent light beam 701 emitted from light source 1 enters polarization beam splitter 52. Light beam 701 having entered polarization beam splitter 52 is reflected by polarization beam splitter 52, is converted into substantially parallel light by collimate lens 53 provided with spherical aberration correction means 93, passes through collimate lens 53, and passes through quarter wavelength plate 54 to be converted into circularly-polarized light. Thereafter, the circularly-polarized light is converted into a convergent beam by objective lens 561, passes through a transparent substrate of optical disk 401, and is condensed on any one of first recording surface 401a, second recording surface 401b, third recording surface 401c, and fourth recording surface 401d that are formed inside optical disk 401. Objective lens 561 is designed to minimize spherical aberration at a middle depth position between first recording surface 401a and fourth recording surface 401d, and spherical aberration that occurs when the light beam is condensed on each of recording surfaces 401a to 401d is removed by spherical aberration correction means 93 moving a position of collimate lens 53 in an optical axis direction.

An opening of objective lens 561 is limited by aperture 551, and numerical aperture NA is 0.85. Light beam 701 reflected by fourth recording surface 401d passes through objective lens 561 and quarter wavelength plate 54, is converted into linearly-polarized light different from the outward way by 90 degrees, and then passes through polarization beam splitter 52. Light beam 701 having passed through polarization beam splitter 52 passes through cylindrical lens 57 and enters photodetector 320. Astigmatism is imparted to light beam 701 when it passes through cylindrical lens 57.

Photodetector 320 has four light receivers (not shown) that each output a current signal according to an amount of light received. From these current signals, a focus error signal by an astigmatism method (hereinafter referred to as an FE signal), a tracking error signal by a push-pull method (hereinafter referred to as a TE signal), and an information signal recorded on optical disk 401 (hereinafter referred to as an RF signal) are generated. The FE signal and the TE signal are amplified and phase-compensated to desired levels, and then supplied to actuators 91 and 92 for focus and tracking control.

Here, if thicknesses t1 to t4 are all the same length, the following problem occurs. For example, when light beam 701 is condensed on fourth recording surface 401d for recording or reproduction with respect to fourth recording surface 401d, a part of light beam 701 is reflected by third recording surface 401c. Since a distance from third recording surface 401c to fourth recording surface 401d and a distance from third recording surface 401c to second recording surface 401b are the same, a part of light beam 701 reflected by third recording surface 401c forms an image on a back side of second recording surface 401b, and the reflected light is reflected again by third recording surface 401c and mixed with reflected light from fourth recording surface 401d that should be read out. Furthermore, since a distance from second recording surface 401b to fourth recording surface 401d and a distance from second recording surface 401b to surface 401z of optical disk 401 are also the same, a part of light beam 701 reflected by second recording surface 401b forms an image on a back side of surface 401z of optical disk 401, and the reflection is reflected again on second recording surface 401b and mixed with the reflected light from fourth recording surface 401d that should be read out. As described above, there is a problem that the reflected light formed on the back sides of the other layers is overlapped in a multiplex manner, and mixed with the reflected light from fourth recording surface 401d that should be read out, so that recording or reproduction are hindered. Such light has high coherence and forms a light-dark distribution due to interference on a light receiving element. Further, since this light-dark distribution fluctuates in accordance with phase difference change from other layer reflected light due to slight variation in intermediate layer thickness inside the optical disk surface, qualities of a servo signal and a reproduction signal are significantly deteriorated. Hereinafter, in the present specification, this will be referred to as a back focus problem.

PTLs 1 to 3 have disclosed configurations where inter-surface thicknesses between the respective recording surfaces are different from one another in order to solve this back focus problem.

Further, since an optical disk system detects the light entering from the surface and reflected on the recording surface, a refractive index of a transparent material that the light passes through from the surface to the optical disk surface also has an influence. Therefore, PTL 4 has disclosed a multilayer disk structure in consideration of the refractive index. An optical disk has information recording surfaces of (N−1) layers, where N is a natural number of four or more, and when a cover thickness and intermediate layer thicknesses are dt1, dt2, . . . , dtN in order from a light incident side, with respect to arbitrary natural numbers i, j, k, m that satisfy i≤j≤k≤m≤N, difference DFF between a sum of dti to dtj and a sum of dtk to dtm is set to 1 um or more. Actual thickness dtr of a portion having refractive index nr is converted into thickness dto having refractive index no that causes a same spread amount of a light beam as a spread amount of the light beam due to thickness dtr. DFF is calculated, based on dto. dto is found by a product of f(n) and dtr. At this time, f(n)=−1.088n³+6.1027n²−12.042n+9.1007 is established.

Furthermore, in order that the thicknesses and the refractive indexes of the intermediate layers are set within a range where spherical aberration falls within a certain range, a target value of actual thickness dtr of a portion where refractive index nr is different from standard value no is found by calculating a product of thickness dto of refractive index no and function g(n) of refractive index n. At this time, g(n)=−1.1111n³+5.8143n²−9.8808n+6.476 is established.

### CITATION LIST

### Patent Literatures

PTL 1: International Publication No. 2010/044245

PTL 2: Unexamined Japanese Patent Publication No. 2007-149210

PTL 3: Unexamined Japanese Patent Publication No. 2007-257759

PTL 4: International Publication No. 2011/024345

### SUMMARY

In recent years, amounts of information produced and recorded all over the world have increased dramatically with improvement of the Internet environment, computer capabilities, and the like. Therefore, there is an increasing need for a high-density, large-capacity optical disk as a medium for storing information safely, inexpensively, and with low energy in a data center and the like. That is, in response to the increase in the amount of information to be stored, it is necessary to achieve an optical disk having a higher recording density than BDXL (registered trademark), which has an expanded BD to three or four layers and a higher recording density. In order to increase the recording density, it is an effective method to make a numerical aperture of the objective lens even higher than the conventional numerical aperture 0.85. However, in the conventional examples, there have been only disclosures on the premise of the numerical aperture of 0.85, and if the numerical aperture is made higher, there has been no disclosure example as to whether or not functions f(n) and g(n) need to be changed from the conventional example, and further, how to change the functions if the functions are changed. Thus, there is a problem that there is no guideline for achieving a large-capacity optical disk that enables a control signal to be stably detected, and an information signal to be stably read.

The present disclosure has been devised in view of the above-mentioned conventional situation, and an object of the present disclosure is to provide an optical disk having a higher density and a larger capacity than the conventional optical disk.

In the present invention, in order to solve the above-described problem, an optical disk described below is configured.

(First Configuration)

A method of manufacturing an optical disk having at least a cover layer, a first information recording surface, a first intermediate layer, a second information recording surface, a second intermediate layer, and a third information recording surface in order from a surface irradiated with a light beam on at least one side, wherein a numerical aperture of an objective lens that converges the light beam on any of the recording surface of the optical disk when information recording or information reproduction of the optical disk is performed is 0.91, standard value dk of each thickness from the surface to the first to third information recording surfaces is set on the premise of standard refractive index no, where k is 1, 2, 3, and a target value of each actual thickness from the surface to the first to third information recording surfaces is determined by a product of conversion coefficient g(n) depending on refractive index n from the first to third information recording surfaces, and standard value dk, and g(n)=−0.859218n³+4.55298n²−7.70815n+5.19674 is established.

(Second Configuration)

A method of manufacturing an optical disk having at least a cover layer, a first information recording surface, a first intermediate layer, a second information recording surface, a second intermediate layer, and a third information recording surface in order from a surface irradiated with a light beam on at least one side, wherein a numerical aperture of an objective lens that converges the light beam on any of the recording surface of the optical disk when information recording or information reproduction of the optical disk is performed is 0.91, when respective actual thicknesses of the cover layer, the first intermediate layer, and the second intermediate layer are trk, where k is 1, 2, 3, effective thickness tk on the premise of standard refractive index no is calculated by a product of actual thickness trk and conversion coefficient f(n) depending on refractive index n of a material forming the thickness, f(n)=−1.37834n³+7.62795n²−14.7462n+10.7120 is established, values of tk are different from one another by a certain value or more, and all of the values of tk are larger than a certain value.

(Third Configuration)

The method of manufacturing the optical disk according to the second configuration, wherein the values of effective thickness tk are different from one another by 1 μm or more, and all of the values of thickness tk are larger than 10 μm.

(Fourth Configuration)

The method of manufacturing the optical disk according to the second configuration or the third configuration, the optical disk having at least the cover layer, the first information recording surface, the first intermediate layer, the second information recording surface, the second intermediate layer, and the third information recording surface in order from the surface irradiated with the light beam on at least one side, wherein the numerical aperture of the objective lens that converges the light beam on any of the recording surface of the optical disk when information recording or information reproduction of the optical disk is performed is 0.91, standard value dk of each of the thicknesses from the surface to the first to third information recording surfaces is set on the premise of standard refractive index no, where k is 1, 2, 3, and the target value of each of the actual thicknesses from the surface to the first to third information recording surfaces is determined by the product of conversion coefficient g(n) depending on refractive index n from the first to third information recording surfaces and standard value dk, and g(n)=−0.859218n³+4.55298n²−7.70815n+5.19674 is established.

(Fifth Configuration)

An optical disk produced by the method of manufacturing the optical disk according to any one of the first to fourth configurations, wherein each of the recording surfaces is provided with a groove having an uneven shape, information is recorded in both a depressed portion and a projected portion, and pitch p of the groove having the uneven shape satisfies p<0.6 μm.

(Sixth Configuration)

An optical information device that reproduces or records the optical disk according to the fifth configuration, including: an optical pickup; a motor that rotates the optical disk; and an electric circuit that receives a signal obtained from the optical pickup, and controls and drives the motor, the objective lens, and a laser light source, wherein the electric circuit corrects spherical aberration generated by the intermediate layer that focus jump is to be performed to prior to the focus jump, and moves a focal position.

(Seventh Configuration)

An information processing method of reproducing and recording the optical disk according to the fifth configuration, including: an optical pickup; a motor that rotates the optical disk; and an electric circuit that receives a signal obtained from the optical pickup, and controls and drives the motor, the objective lens, and a laser light source, wherein the electric circuit corrects spherical aberration generated by the intermediate layer that focus jump is to be performed to prior to the focus jump, and moves a focal position.

According to the present disclosure, quality of the servo signal and the reproduction signal can be improved by preventing the back focus problem and reducing the interference between the reflected lights on the recording surfaces in the multilayer (multi-surface) structure optical disk. In particular, the influence of crosstalk from the adjacent recording surface can be reduced to improve the reproduction signal quality, and a higher-density optical disk can be achieved. Further, in the multilayer disk, a remarkable effect is exerted that an amount of spherical aberration caused by the intermediate layer thickness can be kept within a predetermined range, and stable focus jump and pull-in of focus control can be performed.

### BRIEF DESCRIPTION OF DRAWINGS

FIG. 1 is a diagram showing a schematic configuration of an optical disk and an optical pickup according to a first exemplary embodiment of the present invention.

FIG. 2 is a diagram showing a layer configuration of the optical disk according to the first exemplary embodiment of the present invention.

FIG. 3 is a diagram showing reflected light on an information recording surface that recording or reproduction is to be performed to.

FIG. 4 is a diagram showing reflected light of an information recording surface other than the information recording surface that recording or reproduction is to be performed to.

FIG. 5 is a diagram showing reflected light of an information recording surface other than the information recording surface that recording or reproduction is to be performed to.

FIG. 6 is a diagram showing reflected light of an information recording surface other than the information recording surface that recording or reproduction is to be performed to.

FIG. 7 is a relationship diagram showing a relationship between an FS signal amplitude and an inter-surface thickness difference between two surfaces of the optical disk.

FIG. 8 is a diagram showing a relationship between a thickness of a base material of the optical disk and jitter.

FIG. 9 is a diagram showing a layer configuration of a three-layer optical disk according to the first exemplary embodiment of the present invention.

FIG. 10 is an explanatory diagram showing refractive index dependency of a coefficient for converting an actual thickness to a standard refractive index in the related art.

FIG. 11 is an explanatory diagram showing refractive index dependency of a coefficient for converting an actual thickness into a standard refractive index according to the first exemplary embodiment of the present invention.

FIG. 12 is an explanatory diagram showing a coefficient for converting a thickness at the standard refractive index to an actual thickness at an actual refractive index according to the first exemplary embodiment of the present invention.

FIG. 13 is an explanatory diagram showing a conversion coefficient from a thickness at the standard refractive index to an actual thickness target value with an amount of spherical aberration used as a reference in the related art.

FIG. 14 is an explanatory diagram showing a conversion coefficient from the thickness at the standard refractive index to an actual thickness target value with an amount of spherical aberration used as a reference according to the first exemplary embodiment of the present invention.

FIG. 15 is a schematic explanatory view of an optical information device according to an exemplary embodiment of the present invention.

FIG. 16 is a diagram showing a configuration of a conventional optical disk and optical pickup.

### DESCRIPTION OF EMBODIMENT

Hereinafter, an exemplary embodiment will be described in detail with reference to the drawings as needed. It is noted that a more detailed description than necessary may be omitted. For example, detailed description of already well-known matters and overlapping description of substantially same configurations may be omitted. This is to avoid an unnecessarily redundant description below and to facilitate understanding of those skilled in the art.

Note that the attached drawings and the following description are provided for those skilled in the art to fully understand the present invention, and are not intended to limit the subject matter described in the claims.

### First Exemplary Embodiment

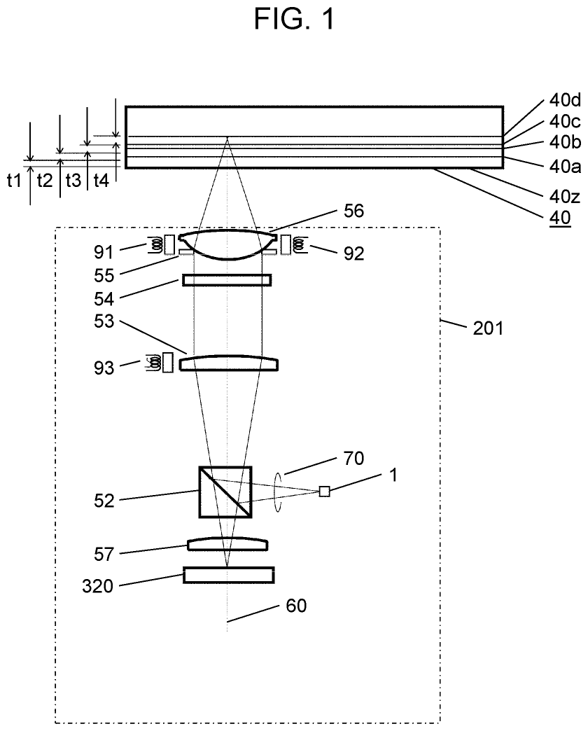

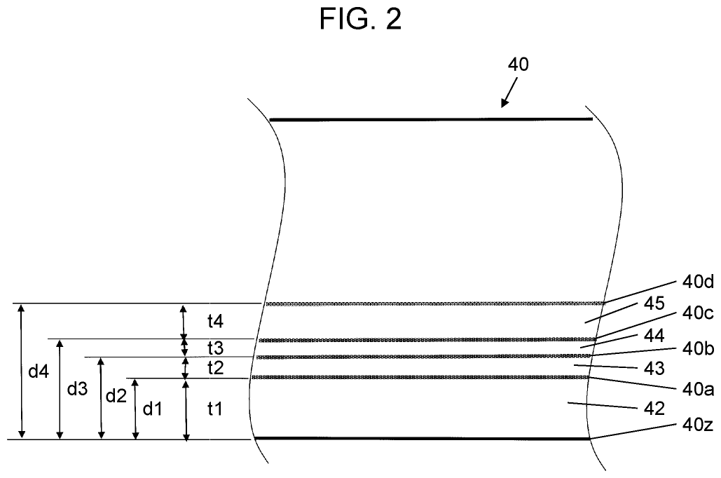

Hereinafter, an exemplary embodiment of the present invention will be described with reference to FIGS. 1 and 2.

FIG. 1 is a diagram showing a schematic configuration of an optical disk and an optical pickup according to a first exemplary embodiment of the present invention, and FIG. 2 is a diagram showing a layer configuration of the optical disk according to the first exemplary embodiment of the present invention.

Optical pickup 201 irradiates optical disk 40 with blue laser light having wavelength λ of 405 nm or the like, and reproduces a signal recorded on optical disk 40.

As an example, in optical disk 40, four information recording surfaces are formed. As shown in FIG. 2, optical disk 40 has first information recording surface 40a, second information recording surface 40b, third information recording surface 40c, and fourth information recording surface 40d in order from a side closer to surface 40z.

Optical disk 40 further has cover layer 42, first intermediate layer 43, second intermediate layer 44, and third intermediate layer 45. A thickness of cover layer 42 (base material from surface 40z to first information recording surface 40a) is t1, a thickness of first intermediate layer 43 (base material from first information recording surface 40a to second information recording surface 40b) is t2, a thickness of second intermediate layer 44 (base material from second information recording surface 40b to third information recording surface 40c) is t3, and a thickness of third intermediate layer 45 (base material from third information recording surface 40c to fourth information recording surface 40d) is t4. A distance from surface 40z to first information recording surface 40a is d1 (□ t1), a distance from surface 40z to second information recording surface 40b is d2 (□ t1+t2), a distance from surface 40z to third information recording surface 40c is d3 (□ t1+t2+t3), and a distance from surface 40z to fourth information recording surface 40d is d4 (□ t1+t2+t3+t4).

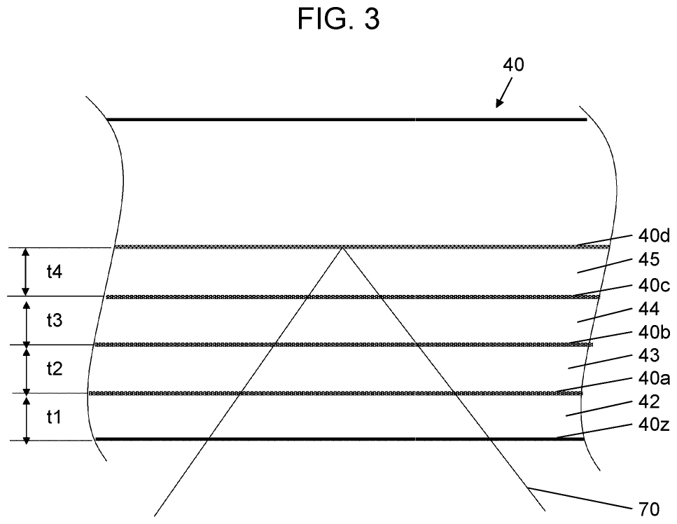

Here, problems in the case where there are four information recording surfaces will be described. As a first problem, interference caused by multifaceted reflected light will be described with reference to FIGS. 3 to 7.

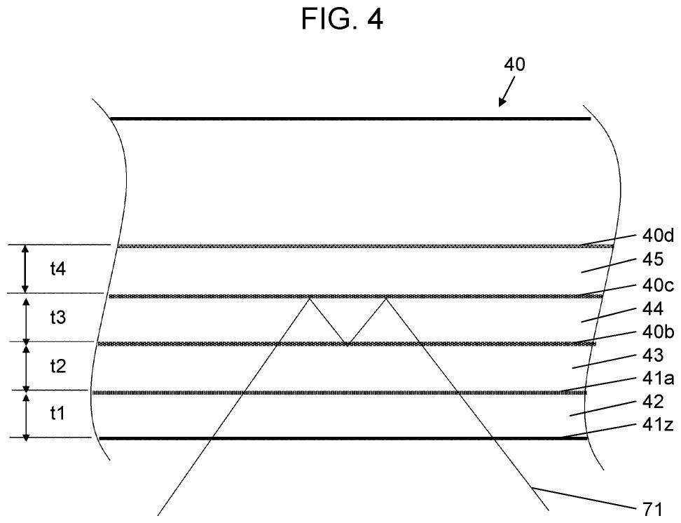

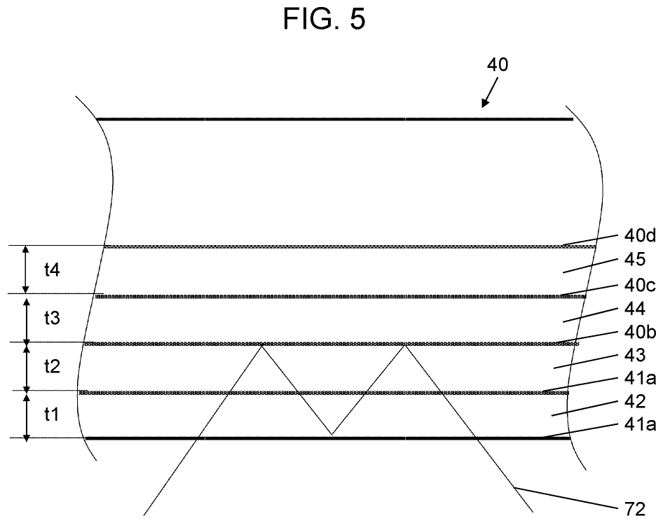

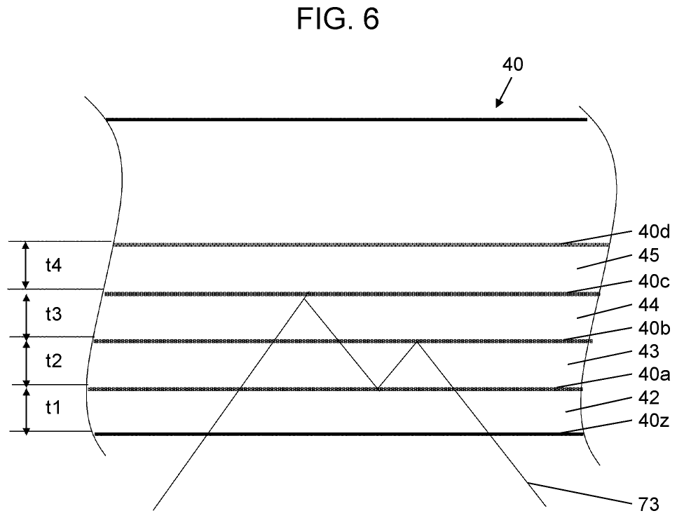

Light flux condensed for reproduction or recording as shown in FIG. 3 is branched into a plurality of light beams described below due to semitransparency of the recording layers,
light beam 70 that is condensed on the reproduction or recording surface, as shown in FIG. 3,
light beam 71 (back focused light on the recording layer) shown in FIG. 4 that is reflected by third information recording surface 40c, focused and reflected by second information recording surface 40b, and reflected again by third information recording surface 40c,
light beam 72 (back focused light to the surface) shown in FIG. 5 that is reflected on second information recording surface 40b, focused and reflected on the surface, and reflected again on second information recording surface 40b,
light beam 73 shown in FIG. 6, which is not focused on the information recording surface, but is reflected in order of third information recording surface 40c, first information recording surface 40a, and second information recording surface 40b.

First, a case where cover layer 42, first intermediate layer 43, second intermediate layer 44, and third intermediate layer 45 all have a same refractive index will be considered. The common refractive index is set to no.

For example, when t4=t3, light beam 70 and light beam 71 pass through a same optical path when exiting from surface 40z, so that light beam 70 and light beam 71 enter photodetector 320 with a same light flux diameter. Similarly, when t4+t3=t2+t1, light beam 70 and light beam 72 pass through the same optical path when light beam 70 and light beam 72 exit from surface 40z, and when t2=t4, light beam 70 and light beam 73 pass through the same optical path when light beam 70 and light beam 73 exit from surface 40z, so that light beam 70 and light beam 72, and light beam 70 and light beam 73 enter photodetector 320 with the same light flux diameter. Here, while a light intensity of each of light beams 71 to 73, which are multifaceted reflected light, is smaller than a light intensity of light beam 70, contrast of interference depends not on the light intensity but on an amplitude of the light. Since an amplitude of light is a magnitude of a square root of the light intensity, the contrast of interference is large even if there is a slight difference in light intensity. When the light enters photodetector 320 with an equal light flux diameter, influence by interference is large, and an amount of light received by photodetector 320 greatly fluctuates due to a slight change in the interlayer thickness, so that it is difficult to detect a stable signal.

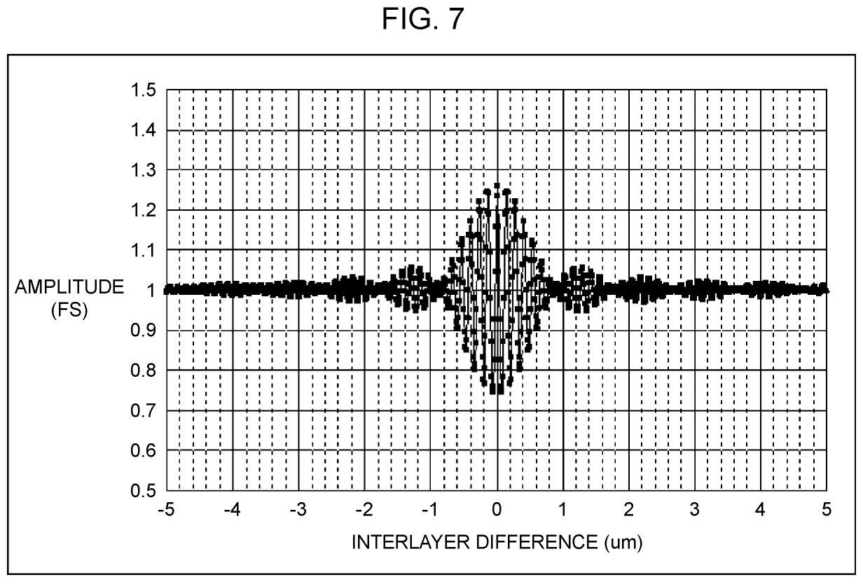

FIG. 7 is a diagram showing an FS signal (a total sum of light intensities) amplitude with respect to a difference in the interlayer thickness when a light intensity ratio between light beam 70 and light beam 71, light beam 72, or light beam 73 is 100:1, and the refractive indexes of cover layer 42 and first intermediate layer 43 are both about 1.6 (1.57). In FIG. 7, a horizontal axis indicates the difference in interlayer thickness, a vertical axis indicates the FS signal amplitude, and there is indicated a value obtained by standardizing only light beam 70 with an amount of DC light received by photodetector 320 on the premise that there is no reflection from multilayer light. Further, as shown in FIG. 7, it can be seen that the FS signal drastically fluctuates when the difference in the interlayer thickness is less than about 1 μm.

Similar to light beam 72 in FIG. 5, even when a difference between thickness t1 of cover layer 42 and a total sum of the thicknesses of first intermediate layer 43 to third intermediate layer 45 (t2+t3+t4) is less or equal to 1 μm, the problem such as the fluctuation in the FS signal occurs.

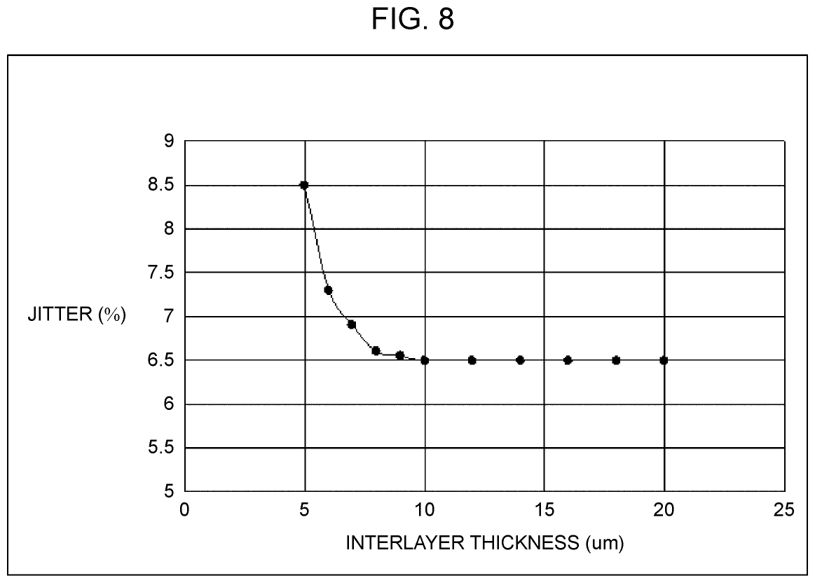

As a second problem, if the interlayer distance between the adjacent information recording surfaces is too small, it is affected by crosstalk from the adjacent information recording surfaces, so that an interlayer distance of a predetermined value or more is required. Therefore, the interlayer thickness is examined and a minimum interlayer thickness is determined. FIG. 8 is a diagram showing a relationship between the interlayer thickness and jitter in a disk having the respective recording layers with substantially a same reflectance. The refractive index is about 1.6. A horizontal axis of FIG. 8 shows the interlayer thickness, and a vertical axis shows a jitter value. Jitter deteriorates as the interlayer thickness becomes thinner, and a point where increase of jitter starts is about 10 μm, and when the interlayer thickness is less than or equal to about 10 μm, drastic deterioration of jitter occurs. Therefore, it is desirable that the interlayer thickness is equal to or more than 10 μm.

A configuration of optical disk 40 according to the first exemplary embodiment of the present invention will be described in more detail with reference to FIG. 2 In the first exemplary embodiment, a structure of the four-layer disk is set to be able to ensure conditions below in consideration of thickness variation in manufacturing in order to solve an adverse influence of the reflected light from the other layers and the surface.

Condition (1): A difference of 1 μm or more between thickness t1 of cover layer 42 and the total sum of the thicknesses of first intermediate layer 43 to third intermediate layer 45 (t2+t3+t4) is ensured. That is, |t1−(t2+t3+t4)|≥1 μm.

Condition (2): Differences between arbitrary two values of t1, t2, t3, t4 are each equal to or more than 1 μm.

Condition (3): A difference of 1 μm or more between a sum of thickness t1 of cover layer 42 and thickness t2 of first intermediate layer 43 (t1+t2), and a sum of thickness t3 of second intermediate layer 44 and thickness t4 of third intermediate layer 45 (t3+t4) is ensured.

While there are several other combinations of layer thicknesses, they are omitted because they do not need to be considered when the cover layer has a value close to t2+t3+t4.

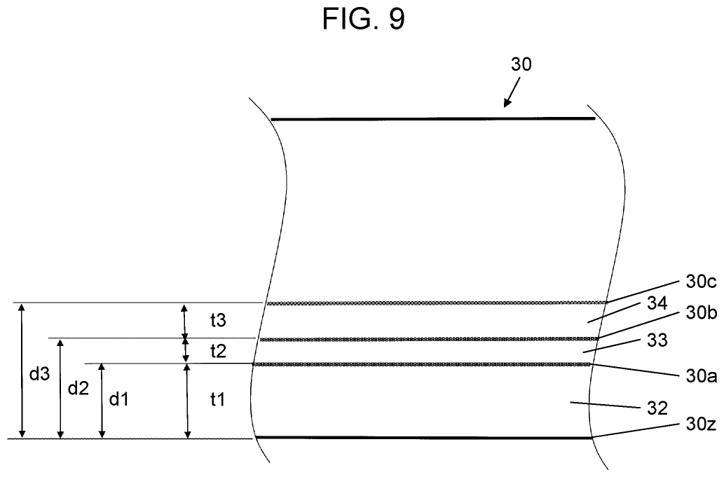

While the above shows a specific example of the structure of the four-layer disk, if it is a three-layer disk as shown in FIG. 9,

Condition (1): A difference of 1 μm or more between thickness t1 of cover layer 32 and a total sum of the thicknesses of intermediate layers 33 to 34 (t2+t3) is ensured. That is, |t1−(t2+t3)|≥1 μm.

Condition (2): Differences between arbitrary two values of t1, t2, t3 are each equal to or more than 1 μm or more.

The above conditions are provided.

Generally, considering an (N−1)-layer disk, where N is a natural number of four or more, the above conditions generally indicate that a difference of 1 μm or more is necessarily provided between a sum of ti to tj and a sum of tk to tm with respect to arbitrary natural numbers i, j, k, m that satisfy i≤j<k≤m≤N, where the cover thickness and the intermediate layer thicknesses are t1, t2, . . . tN, respectively. The cover thickness is a distance from the surface of the optical disk to the nearest information recording surface, and is approximately equal to d1.

Also, in response to the second problem, all the intermediate layer thicknesses are each equal to or more than 10 um. The refractive indexes have been considered to be the same as a standard value and constant so far, and from now on, a case where the refractive indexes are different from the standard value or different from one another on the basis of the layer will be described The back focus of the first problem occurs because the signal light and the other layer reflected light are similar in magnitude and shape on the photodetector. The back focus problem occurs in the case where a focal position difference between the signal light and the other layer reflected light is smaller than 1 um in an optical axis direction on an optical disk side when the refractive index is about 1.6 um. Further, the adjacent layer crosstalk of the second problem occurs in the case where a defocus amount of the signal light is smaller than 10 um on the adjacent track when the refractive index is about 1.6 um. In either case, the defocus amount is important. The defocus amount is also a magnitude of the other layer reflected light or a virtual image of the other layer reflected light at a position where the signal light is focused. This radius is represented by RD. Since the other layer reflected light having a size of RD is projected onto the photodetector, the magnitude of interference and crosstalk depends on this size. Size RD can be said to be a spread amount of light due to the thickness. When the refractive index is different from no=1.6, in order to avoid the back focus and the crosstalk, a condition that the defocus amount or the magnitude of the other layer reflected light or the virtual image of the other layer reflected light is equivalent may be considered. It can also be said that the layer thickness is converted with the spread amount of light due to the thickness used as a reference.

A condition in which when the actual thickness of a portion having refractive index nr is dtr, the same defocus (magnitude of the other layer reflected light or the virtual image of the other layer reflected light) as defocus when the actual thickness of a portion having refractive index no is dt occurs is as follows.

NA=nr−sin(θr)=no−sin(θo) (1)

RD=dtr tan(θr)=dto·tan(θo) (2)

Here, NA is a numerical aperture when the light to the optical disk is narrowed down by objective lens 56. In the conventional example, NA=0.85 is assumed. θr and θo are convergence angles of light in a substance with each of the refractive indexes. Also, sin and tan are sine and tangent functions, respectively.

From (1),

θr=arcsin(NA/nr), θo=arcsin(NA/no) (3)

Here, arcsin is an inverse sine function.

From (2),

dto=dtr−tan(θr)/tan(θo) (4)

or

dtr=dto−tan(θo)/tan(θr) (5)

When the actual thickness of the portion having refractive index nr is dtr, in order to derive a value of the thickness equivalent to a value of the thickness when the refractive index is no, dto may be calculated using expression (4).

In addition, in order to find a value of actual thickness dtr of the portion having refractive index nr that is equivalent to a value of thickness dto in refractive index no, dtr may be calculated using expression (5).

Here, since numerical aperture NA does not appear in expression (4) and expression (5), it seems that NA is not related to a relationship between dto and dtr at first glance, but it has been noticed that both Or and θo depend on NA. Since both Or and θo depend on NA, it has been considered that NA might be related to the relationship between dto and dtr. According to expression (3), both Or and θo have a similar relationship to NA, and in each of expression (4) and expression (5), Or and θo are included in a denominator and a numerator, so that there is also a possibility that the dependency of the relationship between dtr and dto on NA is canceled. Therefore, the relationship between dto and dtr is calculated using a value different from the conventional value, that is, 0.85 for NA. NA is set to 0.91 as a maximum value that can bring about mass production feasibility of the objective lens and a sufficient working distance, and can be industrially and stably achieved for an optical pickup.

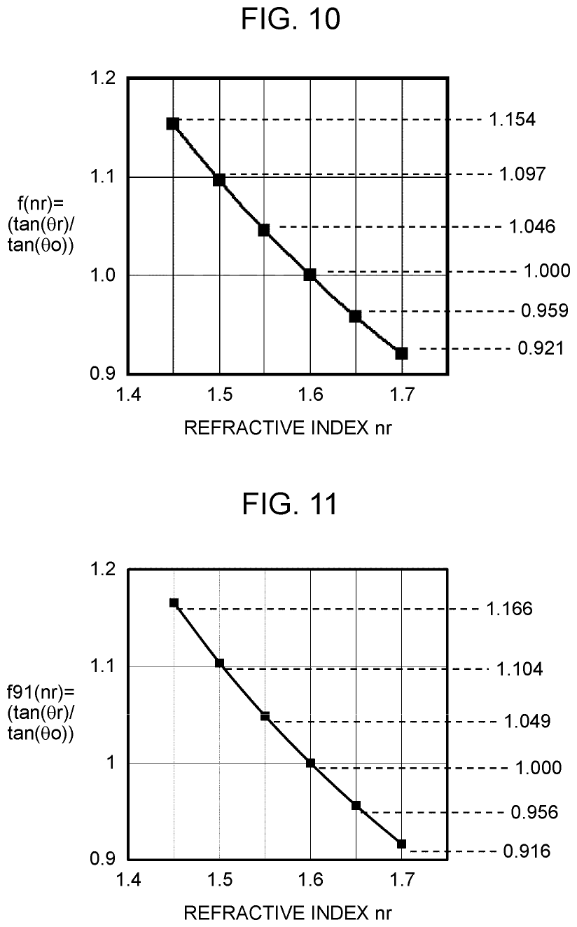

First, FIG. 10 shows a coefficient portion of expression (4) in conventional NA 0.85, that is, tan(θr)/tan(θo) as a function of refractive index nr that is expressed by f(nr). A coefficient portion of expression (4) in NA 0.91, that is, tan(θr)/tan(θo) is shown in FIG. 11 as a function of the refractive index nr that is expressed by f₉₁(nr). In comparison between FIG. 10 and FIG. 11, it can be seen that the relationship between dto and dtr changes depending on NA. Although variables Or and θo that depend on NA are included in the denominator and numerator, the dependency on NA does not completely cancel each other, and as a result, it has been found for the first time that the relationship between dto and dtr changes depending on NA.

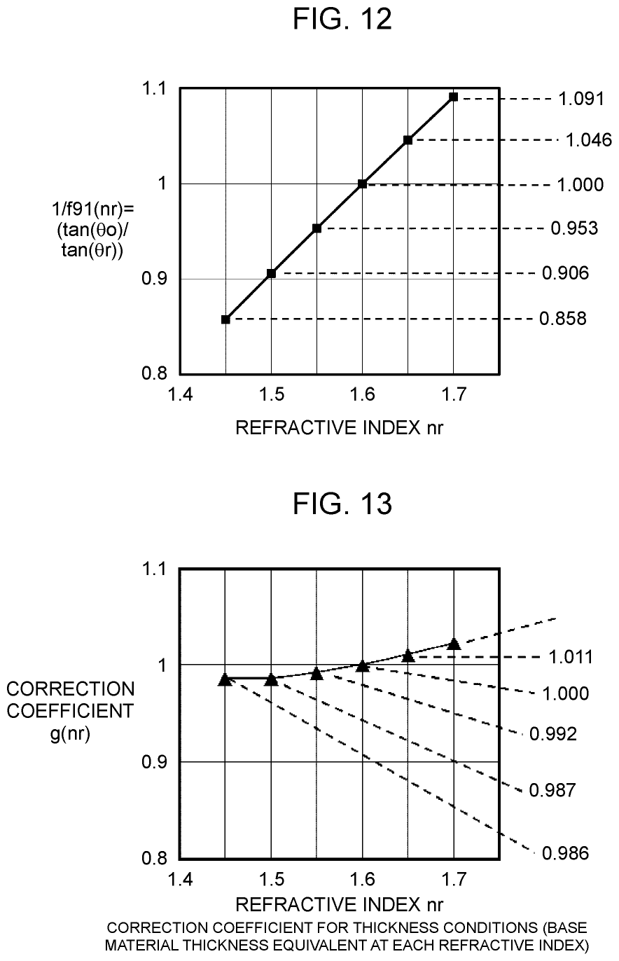

Further, a coefficient portion of expression (5), that is, tan(θo)/tan(θr) is a reciprocal of f₉₁(nr) 1/f₉₁(nr). This is shown as a function of refractive index nr in FIG. 12.

Since f₉₁(nr) and the reciprocal are both smooth curves, they can be represented by polynomials. It has been found that an approximate polynomial with an accuracy of about 0.1% can be obtained by using a cubic expression. That is,

f₉₁(n)=−1.37834n³+7.62795n²−14.7462n+10.7120 (6)

1/f₉₁(n)=0.14446n³−0.83322n²+2.48053n−1.42754 (7)

For simplicity, nr is abbreviated as n in expressions (6), (7).

For example, a four-layer disk having four recording layers will be considered. There is a cover layer having actual thickness tr1 and refractive index nr1 from the surface side that light enters to the first recording layer, and a first intermediate layer having actual thickness tr2 and refractive index nr2 from the first recording layer to a second recording layer, a second intermediate layer having actual thickness tr3 and refractive index nr3 from the second recording layer to a third recording layer, and a third intermediate layer having actual thickness tr4 and refractive index nr4 from the third recording layer to a fourth recording layer. When each of the thicknesses is converted to the thickness at standard refractive index no with the defocus amount used as a reference, t1=tr1×f₉₁(nr1), t2=tr2×f₉₁(nr2), t3=tr3×f₉₁(nr3), t4=tr4×f₉₁(nr4) are established.

To avoid back focus,

|t1−(t2+t3+t4)|≥1 μm, |t2−t3|≥1 μm, |t3−t4|≥1 μm, and |t2−t4|≥1 μm need to be all satisfied.

Further, in order to avoid interlayer interference, t2≥10 μm, t3≥10 μm, and t4≥10 μm also need to be all satisfied.

Furthermore, as a next example, a three-layer disk having three recording layers will be considered. There is a cover layer having actual thickness tr1 and refractive index nr1 from the surface side where light enters to a first recording layer, a first intermediate layer having actual thickness tr2 and refractive index nr2 from the first recording layer to a second recording layer, and a second intermediate layer having actual thickness tr3 and refractive index nr3 from the second recording layer to a third recording layer. When each of the thicknesses is converted to the thickness at standard refractive index no with the defocus amount used as a reference, t1=tr1×f₉₁(nr1), t2=tr2×f₉₁(nr2), t3=tr3×f₉₁(nr3) are established.

To avoid back focus,

|t1−(t2+t3)|≥1 μm and |t2−t3|≥1 μm need to be all satisfied.

Further, in order to avoid interlayer interference, t2≥10 μm and t3≥10 μm also need to be all satisfied.

When a portion between the surface and the recording layer, or between the respective recording layers is configured with layers made of a plurality of materials having different refractive indexes, how much thickness at the standard refractive index a thickness of the layer of each of the materials corresponds to may be obtained by multiplying the actual thickness by above function value f₉₁ to convert the thickness to the thickness at the standard refractive index no with the defocus amount used as a reference, and then performing integration.

For example, in the case where the cover layer having actual thickness tr1 up to the first recording layer is further made of an eleventh layer having thickness tr11 and refractive index nr11, a twelfth layer having thickness tr12 and refractive index nr12, . . . and a 1N-th layer having thickness tr1N and refractive index nr1N, when the thickness of each of the layers is converted to thickness t1 at standard refractive index no with the defocus amount used as a reference, t1=Σtr1k×f₉₁(nrk) is established. Here, E represents the integration from 1 to N for k.

Next, a relationship between a base material thickness and the refractive index from the viewpoint of spherical aberration will be described. The thickness of each of the intermediate layers needs to satisfy a specific condition from the viewpoint of spherical aberration. In order to obtain stability of focus jump, it is desirable that the thickness of the intermediate layer is within a certain range from a standard value and that an amount of spherical aberration can be predicted. Focus jump is an operation of changing a focal position from a certain recording layer to another recording layer. In order to stably obtain a focus error signal in the destination layer when the focus jump is performed, it is desirable that spherical aberration is reduced by, for example, moving collimate lens 53 prior to the focus jump, and that the focus error signal in the destination layer has good quality. For this, it is desirable that a difference in spherical aberration between the recording layers is within a certain range. In addition, when the focus control is started, that is, so-called focus pull-in is performed, it is also desirable that the spherical aberration of the recording layer that focus control is to be performed to is predicted, and that, for example, collimate lens 53 is moved or to reduce the spherical aberration, and that the focus error signal in the destination layer has good quality. Therefore, it is desirable that the spherical aberration caused by cover layer thickness t1 and the intermediate layer thickness is within a certain range.

If the refractive index is different, an amount of spherical aberration changes even if the thickness is the same. Therefore, it is desirable that a target value and an allowable range of the thickness of the intermediate layer is set to keep the amount of spherical aberration within a certain range.

The higher the numerical aperture (NA) of the objective lens in use is, the steeper the spherical aberration changes, depending on the thickness of the transparent base material that light passes through. If the spherical aberration is large, sensitivity of a focus error (focus) signal, which is an index for performing focus control, is different from design, or deterioration such as a decrease in signal amplitude occurs. Therefore, as described above, when the focus control is to be started from a state where the focus control is not performed, or in order to obtain the stability of the focus jump, it is desirable that spherical aberration correction is performed in advance in accordance with the layer for which the focus control is performed. For that purpose, it is desirable that the thickness from the surface to the recording layer, and the thicknesses of the intermediate layers are within a certain range from the standard value. Focus jump is an operation of changing a focal position from a certain recording layer to another recording layer. The standard value and the certain range need to be considered with the spherical aberration used as a reference for the above reasons. Therefore, if the refractive index is different from the standard value, the shape value will be changed in accordance with the refractive index.

Therefore, layer thickness design of the multilayer optical disk may be as follows, for example. First, the refractive index of the material configuring the transparent base material is grasped. Next, in accordance with the obtained refractive index, the actual thickness from the surface to the recording layer and the actual thickness of the intermediate layer are converted and determined from the thickness at the standard refractive index with the spherical aberration used as a reference. For the actual thickness from the surface to the recording layer and the actual thickness of the intermediate layer, a numerical table or a table may be used, but since the spherical aberration has a proportional relationship to the thickness, conversion coefficient g(nr) according to the refractive index is calculated in accordance with a wavelength and the numerical aperture, and the resultant may be used. For example, when the light is passed through a base material having a refractive index of 1.6 and a thickness of 0.1 mm, and when the refractive index of the base material is converted by using an objective lens that converges blue light having a wavelength of 405 nm with a numerical aperture of 0.85 without aberration, thickness ts(nr) (mm) that brings about a minimum aberration is found. Consequently, a conversion coefficient can be found by setting g(nr)=ts(nr)/0.1. FIG. 13 shows a conventionally disclosed conversion coefficient g(nr).

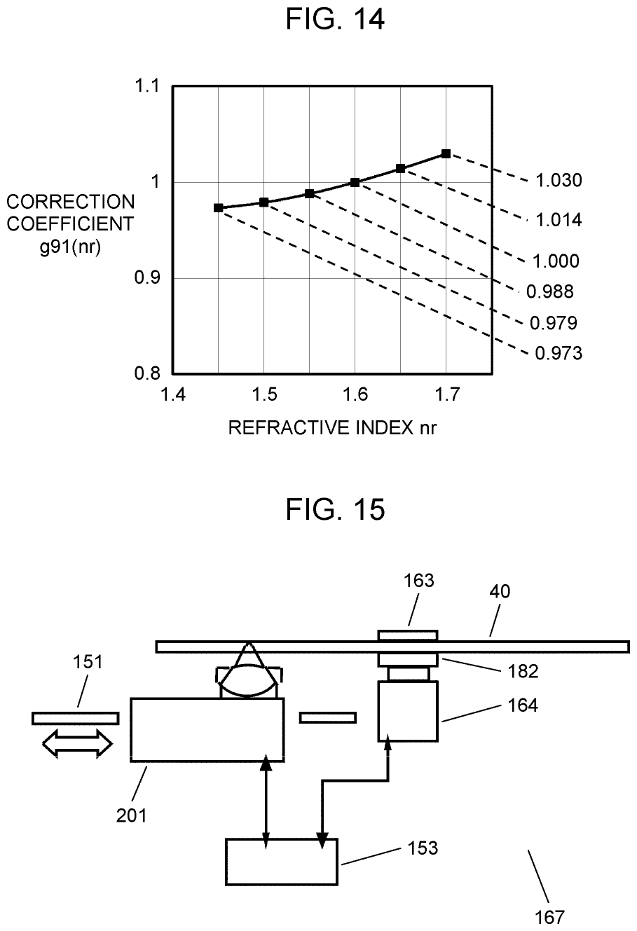

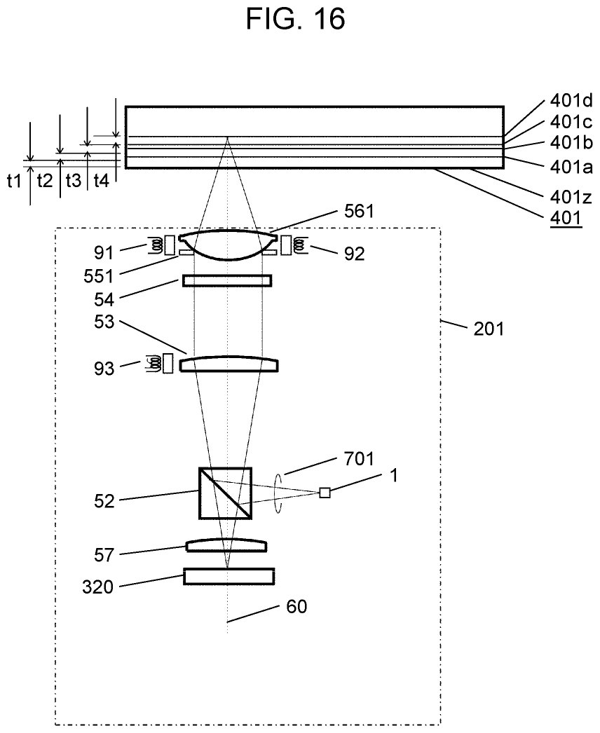

In order to achieve a higher-density optical disk, it is desirable to further increase NA, but 0.91 is appropriate in consideration of feasibility of the objective lens. However, a value of conversion coefficient g(nr) when NA is set to 0.91, and whether conversion coefficient g(nr) when NA is set to 0.91 is different from the case where NA is 0.85 have not been clarified so far. Consequently, an optical system with NA of 0.91 is designed, and on the basis of this, coefficient g₉₁(nr) with the spherical aberration used as a reference is calculated. Calculated coefficient g₉₁(nr) is shown in FIG. 14. By comparing FIGS. 13 and 14, it has been found for the first time that coefficients g(nr) and g₉₁(nr) with the spherical aberration used as a reference are different between the case where NA is 0.85 and the case where NA is 0.91. In the case where NA is 0.91, a design value of the actual thickness may be found by multiplying the thickness at the standard refractive index by g₉₁(nr). Further, by multiplying the actual thicknesses of the cover layer and the intermediate layers by f₉₁(nr), actual thicknesses with the defocus amount at the standard refractive index used as a reference are calculated, and it may be confirmed that a thickness difference is equal to or more than 1 μm, or that each of the intermediate layer thicknesses itself is equal to or more than 10 μm.

Since g₉₁(nr) is a smooth curve, it can be represented by a polynomial. It has been found that an approximate polynomial with an accuracy of about 0.1% can be obtained by using a cubic expression. That is,

g₉₁(n)=−0.859218n³+4.55298n²−7.70815n+5.19674 (8)

For simplicity, in expression (8), nr is abbreviated to n. In addition, the subscripts of g₉₁(n) and f₉₁(n) may be abbreviated, and represented by g(n) and f(n), respectively.

In the present application, the thickness of the base material at which tertiary spherical aberration is actually constant is found in accordance with the refractive index by ray tracing without using approximate calculation, and thus the accurate relationship has been successfully clarified.

Again, from the actual thickness from the surface to the recording layer and the actual thickness of the intermediate layer obtained in this way, the actual thickness of the cover layer can also be known, so that as described above, each of the thicknesses is converted to the thickness at standard refractive index no with the defocus amount used as a reference. Alternatively, the actual thicknesses of the cover layer and the intermediate layers of the actually manufactured optical disk are found. Using these thicknesses, it is also confirmed whether the back focus and the interlayer interference described above can be avoided, and whether or not the thicknesses fall in the design range is determined, and whether the finished optical disk is good or bad is determined.

The thickness from the surface to the recording layer can be found from a sum of the thicknesses of the cover layer and the intermediate layers. In the case of a three-layer disk, the actual thickness from the surface to the first recording layer is tr1, the actual thickness from the surface to the second recording layer is tr1+tr2, and the actual thickness from the surface to the third recording layer is tr1+tr2+tr3. In the case of a four-layer disk, in addition to the three-layer disk, the actual thickness from the surface to the fourth recording layer is tr1+tr2+tr3+tr4.

Since f₉₁(n) is smaller than 1 when n is larger than no, the thickness becomes thinner when converted to the thickness at standard refractive index no with the defocus amount used as a reference. That is, an allowable range is narrowed from the viewpoint of satisfying the intermediate layer thickness≥10 μm for avoiding the interlayer interference. On the other hand, since g₉₁(n) is smaller than 1/f₉₁(n) when n is larger than no, the allowable range toward a thick side is not widened too much from the viewpoint of spherical aberration. Therefore, it is not preferable that the refractive index of the intermediate layer is larger than n0. When the refractive index of the intermediate layer is smaller than n0, a manufacturing margin of the disk becomes wider.

Considering that a refractive index of a commonly used resin such as polycarbonate is about 1.6 and it is desirable that n0=1.6, the refractive index of the intermediate layer is preferably smaller than n0=1.6.

Further, while in the case of a three-layer disk, the condition |t1−(t2+t3)|≥1 μm has been described before, the thicker the cover layer is, the more stably the information can be reproduced against scratches and dirt on the disk surface. Therefore, the condition t1−(t2+t3)≥1 μm is desirable. Since coefficient f₉₁(n) is smaller than 1 when n is larger than no, considering that the thickness becomes thinner when the thickness is converted to the thickness at standard refractive index no with the defocus amount used as a reference, it is easier to satisfy the condition t1−(t2+t3)≥1 μm in the case where the refractive index of each of the intermediate layers (thicknesses t2 to t3) is larger than the refractive index of the cover layer. Therefore, it is desirable that the refractive index of the intermediate layer is larger than the refractive index of the cover layer.

Also, in the case of a four-layer disk, while the condition |t1−(t2+t3+t4)|≥1 μm is described before, the thicker the cover layer is, the more stably the information can be reproduced against scratches and dirt on the disk surface. Therefore, the condition t1−(t2+t3+t4)≥1 μm is desirable. Since coefficient f₉₁(n) is smaller than 1 when n is larger than no, considering that the thickness becomes thinner when the thickness is converted to the thickness at standard refractive index no with the defocus amount used as a reference, it is easier to satisfy the condition t1−(t2+t3+t4)≥1 μm in the case where the refractive index of each of the intermediate layers (thicknesses t2 to t4) is larger than the refractive index of the cover layer. Therefore, it is desirable that the refractive index of the intermediate layer is larger than the refractive index of the cover layer.

The invention of the present application is not limited to any of a rewritable type, a write-once type, and a play-only type, and can be applied to each type of optical disk. In manufacturing the optical disk having at least the cover layer, the first information recording surface, the first intermediate layer, the second information recording surface, the second intermediate layer, and the third information recording surface in order from the surface irradiated with the light beam on at least one side, the numerical aperture of the objective lens for converging the light beam on the recording surface of the optical disk when information recording or information reproduction of the optical disk is performed is 0.91, and standard value dk (k=1, 2, 3) of each of the thicknesses from the surface to the first to third information recording surfaces is set on the premise of standard refractive index no. Further, the target value of the actual thickness from the surface to each of the first to third information recording surfaces is determined by the product of conversion coefficient g(n) depending on refractive index n from the first to third information recording surfaces, and standard value dk.

g(n)=−0.859218n³+4.55298n²−7.70815n+5.19674 is established.

Further, when the actual thicknesses of the cover layer, the first intermediate layer, and the second intermediate layer are trk (k=1, 2, 3), respectively, effective thickness tk on the premise of standard refractive index no is calculated by the product of actual thickness trk and conversion coefficient f(n) depending on refractive index n of a material forming the thickness. At this time, f(n)=−1.37834n³+7.62795n²−14.7462n+10.7120 is established, and values of tk are different from one another by a certain value, desirably by 1 μm or more, and the values of tk are all values larger than a certain value, desirably than 10 μm.

In addition, it is desirable that a recording density is higher than a recording density of a BDXL (registered trademark) disk. For that purpose, it is desirable that a track pitch for lining up information signals is narrower than 0.32 μm of the BDXL (registered trademark) disk. However, a resolution limit of the optical system that forms a condensing spot on the optical disk surface at a wavelength of λ=0.405 μm and with the numerical aperture (NA)=0.85 is λ/(2×NA)=0.238 μm. Even if NA is expanded to 0.91, the resolution limit is 0.222 μm. In order to advance the condensing spot along a center of a track (information string), a TE signal indicating a deviation of the condensing spot from the center of the track is required. However, if the track pitch is narrower than 0.3 μm, the resolution limit is approached, so that the TE signal becomes weaker and a signal-to-noise ratio (S/N) decreases, and the condensing spot cannot be accurately advanced along the center of the track (information string).

Consequently, in the optical disk of the present invention, it is desirable to form a groove by unevenness on the recording surface in advance and record information in both a depressed portion and a projected portion. A track pitch of an uneven groove is double a track pitch of the information string. For example, if the pitch of the information track is 0.3 μm, the pitch of the uneven groove is 0.6 μm. Further, if the pitch of the uneven groove is set to 0.4 μm, the track pitch of the information string can be narrowed to 0.2 μm, and the TE signal having sufficient strength can be obtained, so that the condensing spot can be advanced along the center of the track (information string) with high accuracy.

As described above, in the optical disk according to the first exemplary embodiment of the present invention, the uneven groove is formed on the recording surface, information is recorded on both the depressed portion and the projected portion, and the pitch of the uneven groove is less than or equal to 0.6 μm, preferably equal to or less than 0.4 μm. With the above-described configuration, it is possible to increase the track density to achieve a high density, and it is possible to obtain the effect of being compatible with a stable tracking servo.

Next, FIG. 15 shows an example of an optical information device that performs focus jump.

Optical disk 40 is placed on turntable 182 and rotated by motor 164. Optical pickup 201 shown above is coarsely moved by drive device 151 of the optical pickup to a track where desired information of the optical disk exists.

Optical pickup 201 also sends a focus error signal and a tracking error signal to electric circuit 153 according to a positional relationship with optical disk 40. In response to this signal, electric circuit 153 sends a signal for finely moving the objective lens to optical pickup 201. By this signal, optical pickup 201 performs focus control and tracking control to the optical disk, and optical pickup 201 reads, writes (records), or erases the information. Moreover, a procedure of focus jump is mainly controlled by circuit 153.

In the optical information device of the present exemplary embodiment, for the optical medium described above in the present invention, by moving collimate lens 53, for example, prior to focus pull-in or focus jump, the spherical aberration caused by the base material thickness and the intermediate layer thickness is corrected, the focus pull-in or the focus jump being performed to the base material or the intermediate layer, and then the focal position is moved to make the quality of the focus error signal in the destination layer good. Thus, there is an effect that the focus jump can be performed stably.

### INDUSTRIAL APPLICABILITY

A multilayer optical disk (optical disk) according to the present invention minimizes influence of reflected light on other layers during reproduction of arbitrary layer even when refractive indexes of a cover layer and intermediate layers are different from a standard value. This can reduce influence on a servo signal and a reproduction signal in an optical head.

As a result, it is possible to provide an optical disk having a large capacity that can obtain a high-quality reproduction signal and easily ensuring compatibility with an existing disk.

### REFERENCE MARKS IN THE DRAWINGS

40: optical disk
201: optical pickup
40z: surface
40a: first information recording surface
40b: second information recording surface
40c: third information recording surface
40d: fourth information recording surface
32, 42: cover layer
43: first intermediate layer
44: second intermediate layer
45: third intermediate layer
1: light source
70, 71, 72, 73: light beam
52: polarization beam splitter
53: collimate lens
54: quarter wavelength plate
56: objective lens
57: cylindrical lens
320: photodetector
91: actuator
93: spherical aberration correction means
401: optical disk
401a: first recording surface
401b: second recording surface
401c: third recording surface
401d: fourth recording surface
401z: surface
551: aperture
561: objective lens
701: light beam

1. A method of manufacturing an optical disk having at least a cover layer, a first information recording surface, a first intermediate layer, a second information recording surface, a second intermediate layer, and a third information recording surface in order from a surface irradiated with a light beam on at least one side of the optical disk, the method comprising:
setting a numerical aperture of an objective lens to 0.91 when information recording or information reproduction of the optical disk is performed, the objective lens converging the light beam on the first to third information recording surfaces of the optical disk;
setting a standard value dk of a thickness from the surface to each of the first to third information recording surfaces on a premise of standard refractive index no, where k is 1, 2, 3; and
determining a target value of an actual thickness from the surface to each of the first to third information recording surfaces by a product of a conversion coefficient g(n) depending on a refractive index n from the first to third information recording surfaces, and the standard value dk, and establishing g(n)=−0.859218n³+4.55298n²−7.70815n+5.19674.

2. A method of manufacturing an optical disk having at least a cover layer, a first information recording surface, a first intermediate layer, a second information recording surface, a second intermediate layer, and a third information recording surface in order from a surface irradiated with a light beam on at least one side of the optical disk, the method comprising:
setting a numerical aperture of an objective lens to 0.91 when information recording or information reproduction of the optical disk is performed, the objective lens converging the light beam on the first to third information recording surfaces of the optical disk;
when an actual thickness of each of the cover layer, the first intermediate layer, and the second intermediate layer is trk, where k is 1, 2, 3, calculating an effective thickness tk on a premise of a standard refractive index no by a product of the actual thickness trk and a conversion coefficient f(n) depending on a refractive index n of a material forming a thickness;
establishing f(n)=−1.37834n³+7.62795n²−14.7462n+10.7120;
causing values of tk to be different from one another by a certain value or more; and
causing all of the values of tk to be larger than a certain value.

3. The method of manufacturing the optical disk according to claim 2, wherein
the values of the effective thickness tk are different from one another by 1 μm or more, and
all of the values of the effective thickness tk are larger than 10 μm.

4. The method of manufacturing the optical disk according to claim 2, the optical disk having at least the cover layer, the first information recording surface, the first intermediate layer, the second information recording surface, the second intermediate layer, and the third information recording surface in order from the surface irradiated with the light beam on at least one side of the optical disk, the method comprising:
setting the numerical aperture of the objective lens to 0.91 when information recording or information reproduction of the optical disk is performed, the objective lens converging the light beam on the first to third information recording surfaces of the optical disk;
setting a standard value dk of the thicknesses from the surface to each of the first to third information recording surfaces on the premise of the standard refractive index no, where k is 1, 2, 3; and
determining a target value of an actual thickness from the surface to each of the first to third information recording surfaces by a product of conversion coefficient g(n) depending on the refractive index n from the first to third information recording surfaces, and a standard value dk, and establishing g(n)=−0.859218n³+4.55298n²−7.70815n+5.19674.

5. An optical disk produced by the method of manufacturing the optical disk according to claim 1.

6. The optical disk according to claim 5, wherein
each of the first to third information recording surfaces is provided with a groove having an uneven shape,
information is recorded in both a depressed portion and a projected portion, and
a pitch p of the groove having the uneven shape satisfies p<0.6 μm.

7. An optical information device that reproduces or records the optical disk according to claim 6, the optical information device comprising:
an optical pickup;
a motor that rotates the optical disk; and
an electric circuit that receives a signal obtained from the optical pickup, and controls and drives the motor, the objective lens, and a laser light source,
wherein the electric circuit corrects spherical aberration generated by the intermediate layer that focus jump is to be performed to prior to the focus jump, and moves a focal position.

8. An information processing method of reproducing or recording the optical disk according to claim 6, the information processing method comprising:
providing an optical pickup, a motor that rotates the optical disk, and an electric circuit that receives a signal obtained from the optical pickup, and controls and drives the motor, the objective lens, and a laser light source; and
causing the electric circuit to correct spherical aberration generated by the intermediate layer that focus jump is to be performed to prior to the focus jump, and moves a focal position.
